(19) United States
(12) Patent Application Publication
(10) Pub. No.: US 2026/0368413 A1
(43) Pub. Date: Nov. 19, 2026

(54) SYSTEMS AND METHODS FOR DOCUMENT RECONCILIATION

(71) Applicant: State Farm Mutual Automobile Insurance Company, Bloomington, IL (US)

(72) Inventors: Kerstin Markwardt, Bloomington, IL (US); Bryan Caraway, Bloomington, IL (US); Nuo Xu, Bloomington, IL (US); Dong Feeley, Bloomington, IL (US)

(73) Assignee: State Farm Mutual Automobile Insurance Company, Bloomington, IL (US)

(21) Appl. No.: 19/209,461

(22) Filed: May 15, 2025

(51) Int. Cl. G06F 40/103; G06Q 40/08; G06V 30/412

(52) U.S. Cl. CPC G06F 40/103; G06Q 40/08; G06V 30/412

(57) ABSTRACT

A method for reconciling documents for responding to damage to a property includes receiving a first document prepared by a first party. The method includes identifying first line-items within the first document. The method includes extracting data from the first line-items to generate a first line-item data set. The method includes receiving a second line-item data set prepared by a second party. The method includes generating a comparison of the first and second line-item data sets. Generating the comparison includes identifying a set of data items from the first line-item data set to match with data items from the second line-item data set. Generating the comparison includes identifying a second set of one or more data items from the first line-item data set not to match with data items from the second line-item data set.

### FIELD

The present disclosure generally relates to systems and methods for document reconciliation. More particularly, the present systems and methods relate to reconciling documents for responding to property damage.

### BACKGROUND

Individuals and organizations may use various methods to manage and resolve discrepancies in documents, such as in documents relating to property damage management. However, differences in formats between documents and nonstandard terminology/styles may pose challenges for handlers to address and resolve. Conventional techniques may also have certain ineffectiveness, inefficiencies, fallibilities, and/or other drawbacks as well.

### SUMMARY

In one aspect, a method for reconciling multiple documents for responding to damage to a home or other property may include receiving, by one or more processors, a first document prepared by a first party. The method may include identifying, by the one or more processors, a plurality of first line-items within the first document relating to responding to the damage. The method may include extracting, by the one or more processors, data from the identified first line-items to generate a first line-item data set. The method may include receiving, by the one or more processors, a second line-item data set relating to responding to the damage and prepared by a second party. The method may include generating, by the one or more processors, a comparison of the first line-item data set and the second line-item data set. Generating the comparison may include identifying a first set of one or more data items from the first line-item data set determined to match one or more data items from the second line-item data set. Generating the comparison may include identifying a second set of one or more data items from the first line-item data set determined not to match one or more data items from the second line-item data set.

In some implementations, extracting the data may include extracting descriptions, quantities, and resource amounts associated with the first line-items. In some implementations, generating the comparison may furth include identifying a third set of one or more data items from the second line-item data set determined not to match one or more data items from the first line-item data set. In some implementations, the first party may include a contractor.

In some implementations, receiving the second line-item data set may include receiving a second document including a plurality of second line-items relating to responding to the damage. Receiving the second line-item data set may include extracting, by the one or more processors, the second line-item data set from the plurality of second line-items. In some implementations, the first line-item data set and the second line-item data set may include descriptions. Generating the comparison may include comparing the descriptions and determining whether to identify data items within the first set of data items or the second set of data items based on a similarity of the descriptions.

In some implementations, at least one of the extracting or the generating steps may be performed using one or more large language models. In some implementations, extracting data from the identified first line-items to generate a first line-item data set may include identifying data items of the first line-item data set within the identified first line-items using at least one of a template or a rule set. In some implementations, the extracting step may be performed using a language model. The first document may include a non-standardized format. Extracting data from the identified first line-items to generate a first line-item may include identifying data items of the first line-item data set within the identified first line-items using the language model.

In another aspect, a system to reconcile multiple documents for responding to damage to a home or property includes one or more processing circuits configured to receive a first document prepared by a first party. The one or more processing circuits may identify a plurality of first line-items within the first document relating to responding to the damage. The one or more processing circuits may extract data from the identified first line-items to generate a first line-item data set. The one or more processing circuits may receive a second line-item data set relating to responding to the damage and prepared by a second party. The one or more processing circuits may generate a comparison of the first line-item data set and the second line-item data set. Generating the comparison may comprise the one or more processing circuits to identify a first set of one or more data items from the first line-item data set determined to match one or more data items from the second line-item data set, and identify a second set of one or more data items from the first line-item data set determined not to match one or more data items from the second line-item data set.

In some implementations, extracting the data may comprise the one or more processing circuits to extract descriptions, quantities, and resource amounts associated with the first line-items. In some implementations, generating the comparison may further comprise the one or more processing circuits to identify a third set of one or more data items from the second line-item data set determined not to match one or more data items from the first line-item data set. In some implementations, extracting the data may comprise the one or more processing circuits to extract a first portion of the data using at least one of a template or a rule set. The first portion of the data may be in a standardized data format. The one or more processing circuits may, using one or more AI models,extract a second portion of the data, the first portion of the data in a non-standardized data format.

In some implementations, receiving the second line-item data set may comprise the one or more processing circuits to receive a second document including a plurality of second line-items relating to responding to the damage. The one or more processing circuits may extract the second line-item data set from the plurality of second line-items. In some implementations, the first line-item data set and the second line-item data set may include descriptions. Generating the comparison may comprise the one or more processing circuits to compare the descriptions and determine whether to identify data items within the first set of data items or the second set of data items based on a similarity of the descriptions.

In some implementations, the one or more processing circuits are configured to conduct at least one of the extracting or the generating using one or more language models. In some implementations, the one or more processing circuits are configured to conduct the extracting using a language model. The first document may comprise a non-standardized format. Extracting data from the identified first line-items to generate a first line-item data set may comprise the one or more processing circuits to identify data items of the first line-item data set within the identified first line-items using the language model.

In another aspect, one or more non-transitory computer-readable storage media may have instructions that, when executed by one or more processors, cause the one or more processors to perform operations including receiving a first document prepared by a first party. The operations may include identifying a plurality of first line-items within the first document relating to responding to the damage. The operations may include extracting, using one or more AI models, the one or more AI models selected based on a format of the first document, data from the identified first line-items to generate a first line-item data set. The operations may include receiving a second line-item data set relating to responding to the damage and prepared by a second party. The operations may include generating, using the one or more AI models, a comparison of the first line-item data set and the second line-item data set. Generating the comparison may include identifying a first set of one or more data items from the first line-item data set determined by the one or more AI models to match one or more data items from the second line-item data set. Generating the comparison may include identifying a second set of one or more data items from the first line-item data set determined by the one or more AI models not to match one or more data items from the second line-item data set.

In some implementations, identifying the plurality of first-line items includes identifying recorded information associated with each first-line item of the plurality of first line items. Extracting the data from the identified first line-items may include extracting a description from the recorded information for each first line-item of the plurality of line-items.

Advantages will become more apparent to those skilled in the art from the following description of embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary system to reconcile documents, according to some embodiments.

FIG. 2 is a flow diagram of an exemplary computer-implemented or computer-based method for reconciling documents, according to some embodiments.

FIG. 3 is a diagram of an exemplary computer-implemented or computer-based process of identifying line-item data, according to some embodiments.

FIG. 4 is a diagram of an exemplary computer-implemented or computer-based process of extracting line-item data, according to some embodiments.

FIG. 5 is a diagram of an exemplary computer-implemented or computer-based process of matching line-item data, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Following below are more detailed descriptions of various concepts related to, and implementations of, methods, apparatuses, and systems for reconciling documents. For example, multiple documents may be prepared detailing aspects of replacements or repairs to address home or other property damage.

The systems and methods discussed herein provide an automated method of reconciling multiple documents for responding to damage to the home or other property. Specifically, the systems and methods described herein include generating a comparison, such as a reconciliation document, between a first line-item data set and a second line-item data set, according to some implementations. The first line-item data set may be generated by extracting from a first document prepared by a first party, such as a contractor. The second line-item data set may be prepared by a second party, such as a protection service providing protection against damage to homes or other property and be retrieved from a database. To assist the comparison between line-item data sets, the first line-item data set may be generated with the same format as that of the second line-item data set, in some implementations. For example, predefined rules and/or templates and/or one or more AI models may be utilized to extract relevant data from the first document and organize the data into a first data structure of predefined format or layout. A second data structure of the predefined format may be generated from the second document in the same way. In some implementations, because both data structures are generated in the predefined format, the line-items within the data structures are organized such that they are easily identifiable and comparable.

Through utilization of the one or more AI models, the line-items within the data structures can be matched even where the line-items are described with varying language. Therefore, the line-item terminology and/or descriptions used by each party need not be converted into common language to match the line-items, in some implementations. In other methods for document reconciliation, the documents of different formats are not converted to a common format. The different document formats may include differing terminology, unnecessary information, or may be laid out in such a way that line-item information is not easily identifiable. Therefore, each of the documents must be carefully analyzed and research may be required to understand common terminology, both of which may lead to confusion to a party responsible for reconciling the documents and/or difficulty designing or implementing an algorithm to automatically reconcile the documents, such as using fixed rules.

Further, some embodiments of the systems and methods described herein include identifying a specific set of data items to match on the reconciliation document. For example, a specific set of data items from the first line-item data set may be identified to match one or more data items from the second line-item data set, or vice versa. Various AI models, such as various large-language models (LLMs), may be utilized for matching the line-items. The LLMs may be trained to recognize language patterns, for example within line-item descriptions. Therefore, data items from each line-item data set that correspond to the same line-item may be matched, despite any variations in language, such as differences in terminology, grammar, syntax, etc., between the data sets. These items may be considered to be or identified as matched when it is determined that the line-items match with a high degree of confidence. Therefore, the likelihood that line-items that are not similar inadvertently match are significantly reduced. Additionally, a human-in-the-loop (HITL) approach may be utilized that allows a user to identify unmatched line-items that should be a match and/or matched items that should not be matched, which may in turn be provided as input to the system to revise the reconciliation report. It should be understood that, in various embodiments described herein, items need not be exactly the same as one another in order to be considered or be identified as matches.

Before turning to the figures, which illustrate certain implementations in detail, it should be understood that the present disclosure is not limited to the details or methodology set forth in the description or illustrated in the figures. The various concepts introduced above and discussed in greater detail below can be implemented in any of numerous ways. It should also be understood that the terminology used herein is for the purpose of description only and should not be regarded as limiting.

### Overview

Referring to the Figures, computer systems and computer-implemented methods for reconciling multiple documents are provided. For example, a customer may experience a home or property damage that they would like to be repaired or otherwise responded to. Prior to responding to the damage, a provider (e.g., a property protection service) may provide an estimate of the services or resources required to respond to the damage, which may be recorded in a provider report. Similarly, a contractor may provide an estimate of the services or resources required to respond to the same damage, which may be recorded in a contractor report.

The system may receive both the provider report and the contractor report to create a reconciliation report that highlights discrepancies between the estimate from the provider and the estimate from the contractor. The system may extract line-item data from the provider report and reformat the extracted line-item data into a first data set. Similarly, the system may extract line-item data from the contractor report and reformat the extracted line-item data into a second data set. Advantageously, the system may perform the line-item extraction using one or more models (e.g., machine-learning models, rule-based models, template-based models, or generative artificial intelligence models, among others), thereby automating the data extraction and allowing the data to be extracted from multiple formats of reports.

Once the line-items are extracted from each report, the system may compile the reconciliation document. Advantageously, the system may extract the data in such a way that both the first and second data sets are organized in the same format. Organizing both data sets in a common format may assist with a comparison between the line-items in each data set. During this comparison, the system may identify matching line-items between data sets (e.g., line-items reported by both the provider and the contractor). These matching line-items can be organized on the reconciliation document in such a way that a user (e.g., the provider or the contractor) can easily identify the discrepancies between the information relating to each matching line-item. Additionally, line-items from either of the data sets that do not match a line-item from the other data set may be separately organized on the reconciliation document in such a way that the user can easily identify line-items that the provider estimated but the contractor did not estimate, or vice versa.

Utilizing different models to extract line-item data from documents based on the format of the document may improve computing efficiency of the system. The documents are compared to templates having a preferred format or pattern. Thus, when the documents are determined to be in the preferred format, a rule-based model may be implemented to accurately extract line-item data from the document into a data set. Conversely, when the documents are not in the preferred format, a different model, such as a generative model, may be implemented to accurately extract the line-item data from the document to form the data set. Therefore, comparison of the data between line sets may be efficiently compared regardless of its original format, which reduces the likelihood that the data is incorrectly identified or compared.

The systems and methods described herein may reduce computing time and power. For example, the systems and methods described herein are configured to extract line-item data from a variety of document formats. Thus, documents of different formats need not be separately analyzed. Additionally, through use of the various AI models, the line-item data from the documents of various formats may be automatically extracted through use of predefined rules or prompts, which reduces the time and power required for the system to identify line-items within the documents. For example, each line-item in a document typically takes one minute or longer to reconcile, with most reconciliation documents having many more line-items (e.g., twenty or more). The time spent to reconcile each individual line-item therefore quickly accumulates for users or companies reconciling many documents, for example for a company performing over 500,000 document reconciliations, of one estimate type alone, in a year. Therefore, the systems and methods herein may reduce the computing time for such users or companies to perform reconciliations, for example on the order of hundreds of thousands of hours per year.

Advantageously, this may streamline claim estimate reconciliation between two or more parties. For example, the systems and methods herein automatically extract line-item data from various sources and standardize the extracted data into a common format with comparable metrics. This reduces the need to employ various processes for standardizing the various data formats. This also promotes accuracy of reconciliation documents. For example, matching line-items are automatically matched with a high degree of confidence through use of various models, templates, and/or AI models. Therefore, the remaining line-items that do not have a match with a high degree of confidence are separated in the reconciliation report. This reduces the likelihood that the models inaccurately match line-items that should not be matched (e.g., reduces erroneous responses from the models). Implementation of the various AI models may further streamline the reconciliation process. For example, the AI models may be configured to identify matching line-items despite the line-item data having differing terminology. Therefore, the amount of unmatched line items that should be matched are reduced.

### Reconciliation system and Methods

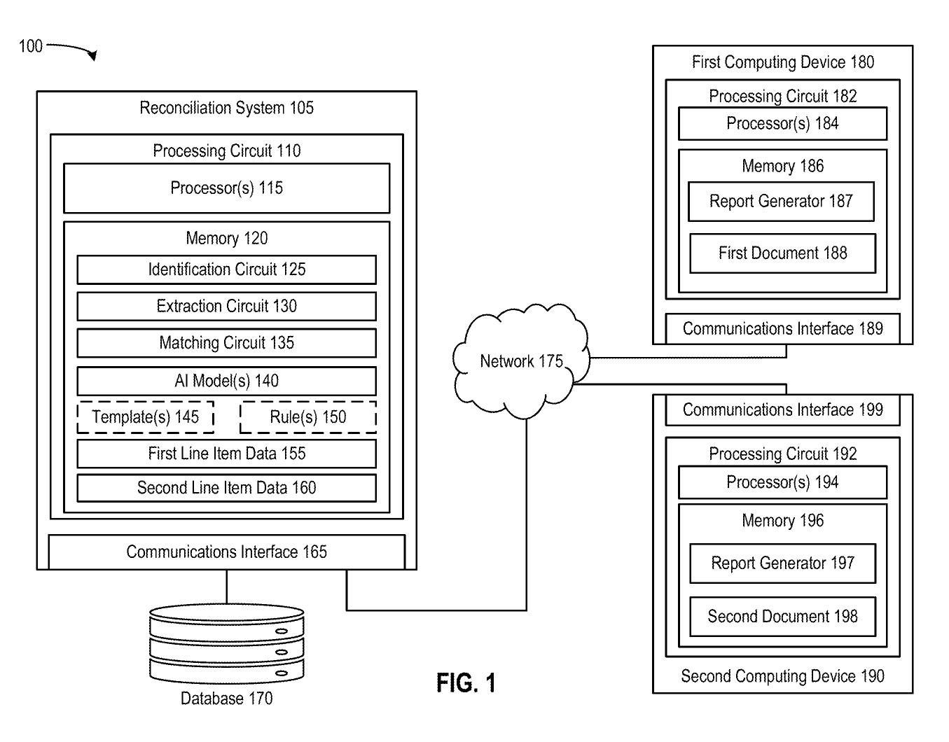

Referring to FIG. 1, a block diagram of an exemplary system for document reconciliation, shown as system 100, is shown, according to some embodiments. It should be noted that the number and type of components shown is merely illustrative and, in various implementations, implementations of the system 100 may have additional, fewer, and/or different components than those illustrated in FIG. 1 including those mentioned elsewhere herein. The system 100 may include at least one reconciliation system 105, a database 170, and a network 175. The system 100 may also include a plurality of computing devices, shown as first computing device 180 and second computing device 190.

The components of the system 100 may be connected, or in wired or wireless communication, via a network 175. The network 175 may include computer networks such as the Internet, local, wide, metro or other area networks, intranets, satellite networks, other computer networks such as voice or data mobile phone communication networks, combinations thereof, or any other type of electronic communications network. The network 175 may include or constitute a display network. In some implementations, the network 175 facilitates secure communication between components of the system 100. As a non-limiting example, the network 175 may implement transport layer security (TLS), secure sockets layer (SSL), hypertext transfer protocol secure (HTTPS), and/or any other secure communication protocol. It should be noted that the number and type of components shown are merely illustrative, and in various embodiments, implementations of the system 100 may have additional, fewer, and/or different components than those illustrated in FIG. 1.

The network 175 may facilitate communication between various nodes, such as the reconciliation system 105, the first computing device 180, and the second computing device 190. In some implementations, data flows through the network 175 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 175 layered over an OSI layer-3 network protocol such as Internet Protocol (IP), e.g., IPv4 or IPv6.

Generally, the reconciliation system 105, the first computing device 180, and the second computing device 190 may include one or more logic devices, which may be one or more computing devices equipped with one or more processing circuits that run instructions stored in a memory device to perform various operations. For example, the reconciliation system 105 includes processing circuit 110 that runs the instructions stored in memory 120. The first computing device 180 includes processing circuit 182 that runs the instructions stored in memory 186. The second computing device 190 includes processing circuit 192 that runs the instructions stored in memory 196. The processing circuits (e.g., processing circuit 110, processing circuit 182, and processing circuit 192) may be made up of various components such as a microprocessor, an ASIC, or an FPGA, and the memory device may be any type of storage or transmission device capable of providing program instructions.

Each system or device in the system 100 may include one or more processors. The memory (e.g., memory 120, memory 186, and/or memory 196) may store programming logic (e.g., computer or machine-readable instructions) that, when executed by one or more processors, controls the operation of the corresponding system or device (e.g., causes the one or more processors to perform operations). For example, processor(s) 115 execute the programming logic stored in the memory 120. Processor(s) 184 may execute the programming logic stored in the memory 186. Processor(s) 195 may execute the programming logic stored in the memory 196. The memory may also store data in databases.

Each system or device in the system 100 may include one or more network interfaces or communications interfaces. For example, the processing circuit 110 may be communicably coupled to a communications interface 165. The processing circuit 182 may be communicably coupled to a communications interface 189. The processing circuit 192 may be communicably coupled to a communications interface 199. The network interfaces (e.g., the communications interface 165, the communications interface 189, and/or the communications interface 199) may allow the systems and devices in the system 100 to communicate wirelessly or otherwise. The network interfaces can be direct (e.g., local wired or wireless communications) and/or via a communications network (e.g., the network 175). For example, the network interfaces may include Ethernet cards and ports for sending and receiving data via an Ethernet-based communications link or network. The network interfaces may also include Wi-Fi transceivers for communicating via a wireless communications network (e.g., the network 175). The network interfaces can include power line communications interfaces. The network interfaces can include Ethernet interfaces, USB interfaces, serial communications interfaces, and/or parallel communications interfaces.

The memory 120 is shown as including several components, including identification circuit 125, extraction circuit 130, matching circuit 135, artificial intelligence (AI) model(s) 140, template(s) 145, rule(s) 150, first line-item data 155, and second line-item data 160. In some examples, these components may be implemented as instructions stored within the memory 120 or one or more other computer-readable storage media that are executable by the processor(s) 115 to perform various functions described herein. In some implementations, the components may additionally or alternatively be implemented in part or in whole using hardware. All such alternatives are contemplated within the scope of the present disclosure.

The AI Model(s) 140 may be implemented by one or more components in the memory 120 to perform various operations described further herein. The AI Model(s) 140 may include various model types, including rule-based models (e.g., expert systems, decision-making algorithms, production rule systems, association rule learning, Learning Classifier Systems (LCS), Inductive Logic Programming (ILP), etc.) that operate on predefined rules, such as the rule(s) 150 stored in the memory 120. The AI Model(s) 140 may include template-based models (e.g., form recognition templates, template-based data extraction, etc.) that operate using predefined templates, such as the template(s) 145 stored in the memory 120. The AI Model(s) 140 may include generative AI models (e.g., generative pre-trained transformers (GPT), bidirectional encoder representations from transformers (BERT), or other transformer-based models, generative adversarial networks (GAN), variational autoencoders (VAE), recurrent neural networks (RNN), autoregressive models, etc.). The AI Model(s) 140 may include other various model types, including various Machine Learning (ML) models, Deep Learning Models, Natural Language Processing (NLP) models, Large Language models (LLM) or other language models, Hybrid Models, among other various AI model types.

As used herein, a “line-item” may refer to any data entry or text entry associated with repairing or replacing damaged property. Claim estimates relating to these damages may be divided into line-items to provide an itemized estimate of the total claim amount. For example, line-items may include materials, labor, equipment, permits, costs, tax, or other items associated with the damage repair. It should be understood that, while various embodiments describe the data being organized into line-items, the present disclosure is not limited to data organized into lines, and the features of the present disclosure may be utilized in conjunction with any type of data (i.e., “line-item” as utilized herein should not be construed as limited to only data organized into lines or other linear structures).

In some implementations, the identification circuit 125 may identify a plurality of line-items within a provided document. For example, the processor(s) 115 may receive a document from the database 170 or the network 175 and provide the document to the identification circuit 125. The identification circuit 125 may be configured to locate or otherwise identify text data contained in the document. The identification circuit 125 may be operatively coupled to the extraction circuit 130, such that the identification circuit 125 may transmit the identified data to the extraction circuit 130. The extraction circuit 130 may be configured to extract the identified data from the document, for example in a tabular format. In some implementations, the extraction circuit may store the extracted first line-item data 155 and/or the extracted second line-item data 160. The matching circuit 135 may be configured to match the first line-item data 155 and the second line-item data 160. In some implementations, the extraction circuit 130 and the matching circuit 135 are operatively coupled, such that the extraction circuit 130 may provide the matching circuit 135 with the extracted first line-item data 155 and/or the second line-item data 160. Additionally or alternatively, the matching circuit 135 may retrieve the first line-item data 155 and the second line-item data 160 from the memory 120.

In some implementations, the first computing device 180 may be a computing device of a first party (e.g., a contractor, a specialist, a property manager, or another party that is third-party to the reconciliation system 105). The memory 186 is shown to include a report generator 187 and a first document 188. The report generator 187 may be configured to receive input data from a user of the first computing device 180 to create a report relating to a home or property damage event (e.g., roof damage, siding damage, structural home/domicile damage, vehicle damage, personal property damage, etc.). Accordingly, the first document 188 may refer to the outputted report from the report generator 187, which may be stored in the memory 186.

In some implementations, the second computing device 190 may be a computing device of a second party (e.g., a property protection service, such as an insurance company, or another party that is a primary entity associated with the reconciliation system 105). The memory 196 is shown to include a report generator 197 and a second document 198. The report generator 197 may be configured to receive input data from a user of the second computing device 190 to create a report relating to a home or property damage event. Accordingly, the second document 198 may refer to the outputted report from the report generator 197, which may be stored in the memory 196.

The first document 188 and the second document 198 may be associated with the same home or property damage event. In some implementations, the reconciliation system 105 may be configured to reconcile data discrepancies between the first document 188 and the second document 198. Accordingly, the reconciliation system 105 may identify and/or resolve differences in the data provided by the user of the first computing device 180 and the second computing device 190.

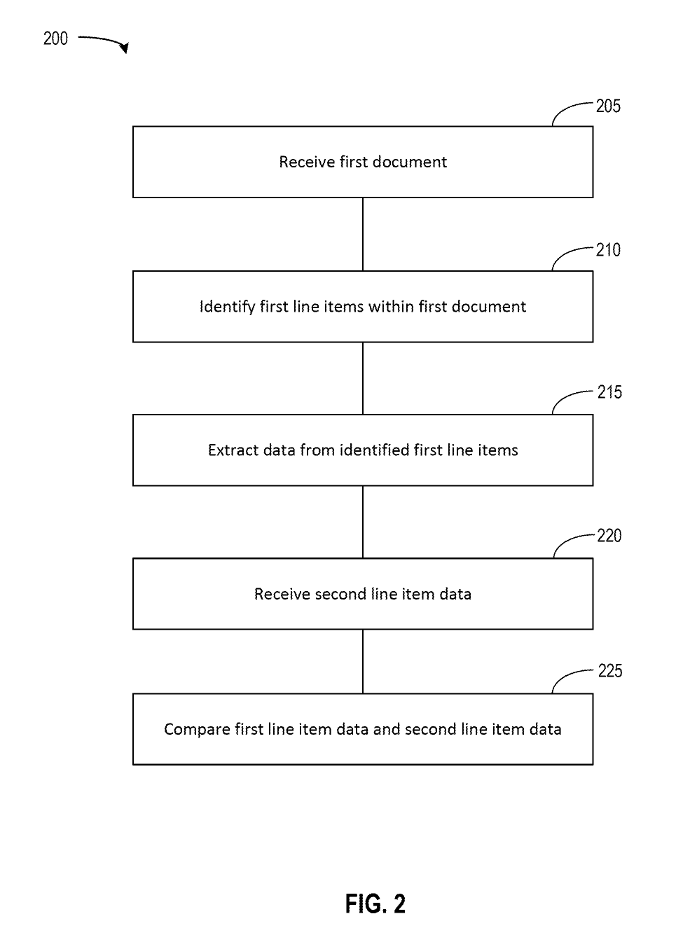

Referring now to FIG. 2, a flow diagram is shown for an exemplary computer-implemented or computer-based method 200 for reconciling documents described with respect to FIG. 1, according to some embodiments. In various embodiments, the processor(s) 115 of the reconciliation system 105 performs the method 200. However, it should be understood that any computing system described herein may perform any or all of the operations described in connection with the method 200.

At step 205, a first document may be received. For example, the first document 188 may be received, by the processor(s) 115, from the first computing device 180. The first document 188 may be generated by the report generator 187 in response to a damage event. For example, a first party (e.g., a contractor or other third-party to the reconciliation system 105) may be contacted to assess a roof damage reported by a customer. The contractor may provide input data to the report generator 187 to generate a report (e.g., the first document 188) corresponding to the roof damage. The communications interface 189 may be interfaced with the communications interface 165 (e.g., through the network 175) to transmit the first document 188 to the reconciliation system 105. While the present disclosure provides roof damage as an example of the type of damage for which the features of the present disclosure may be utilized, it should be understood that this disclosure could be utilized to address any type of property damage (e.g., siding, structural, vehicle, personal property, etc.). All such implementations are contemplated within the scope of the present disclosure.

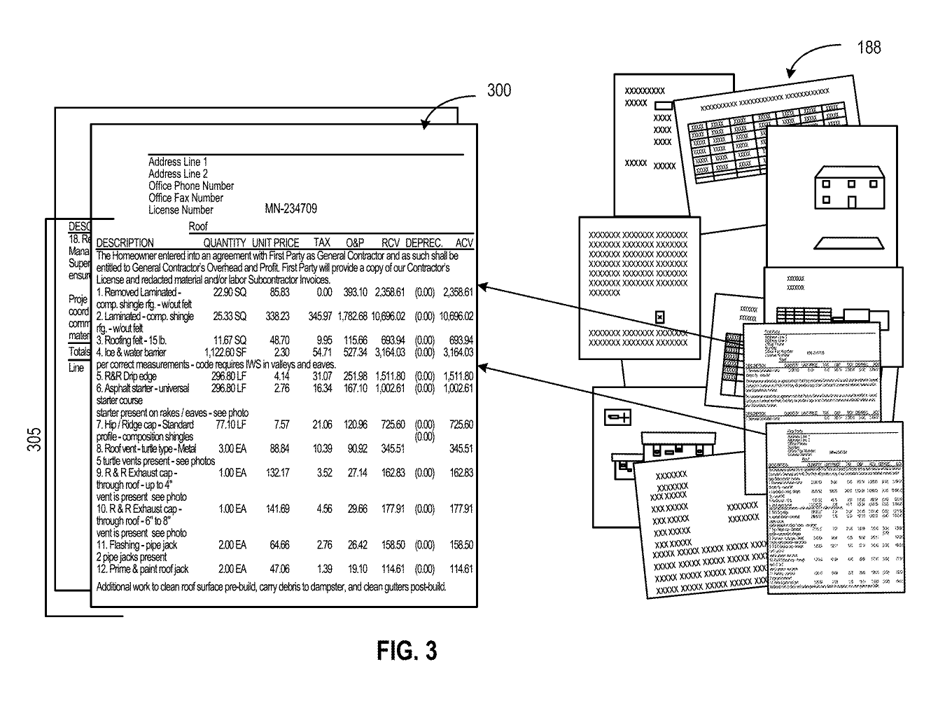

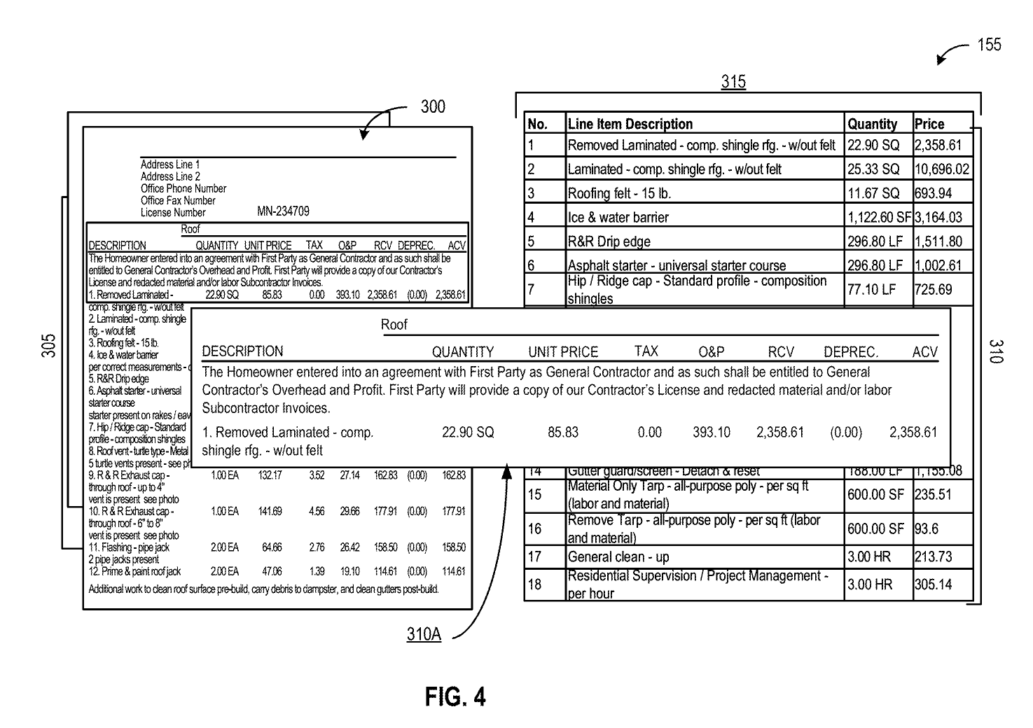

At step 210, first line-items within the first document may be identified. For example, the identification circuit 125 may identify a plurality of pages, sections, or other portions of the first document 188 that contain data relating to responding to the damage, such as identified line-item page(s) 300 (shown in FIGS. 3 and 4). The identification circuit 125 may be configured to locate or otherwise identify text within the first document 188. In some instances, the first document 188 may be received in a document format in which text data is not easily recognized (e.g., Portable Document Format (PDF), Tagged Image File Format (TIFF), Joint Photographic Experts Group (JPEG), Portable Network Graphics (PNG), etc.). The identification circuit 125 may be configured to identify the text within such document formats and convert the documents into a document format more compatible with text data relative to the original document format (e.g., Plain Text File (TXT), Rich Text Format (RTF), HyperText Markup Language (HTML), etc.).

In some implementations, the identification circuit 125 may identify the identified line-item page(s) 300 using one or more of the AI model(s) 140. For example, the identification circuit 125 may include, or be operatively coupled to, a template-based AI model 140. The template-based AI model 140 may be trained to recognize patterns between input data and one or more template(s) 145. For example, the template(s) 145 may include formats or other patterns relating to a preferred data format or organizational data structure. The identification circuit 125 may input the identified line-item page(s) 300 into the template-based AI model 140 to determine an affinity between the format of the first document 188 (or the format of the identified line-item page(s) 300) and the format(s) provided in the template(s) 145.

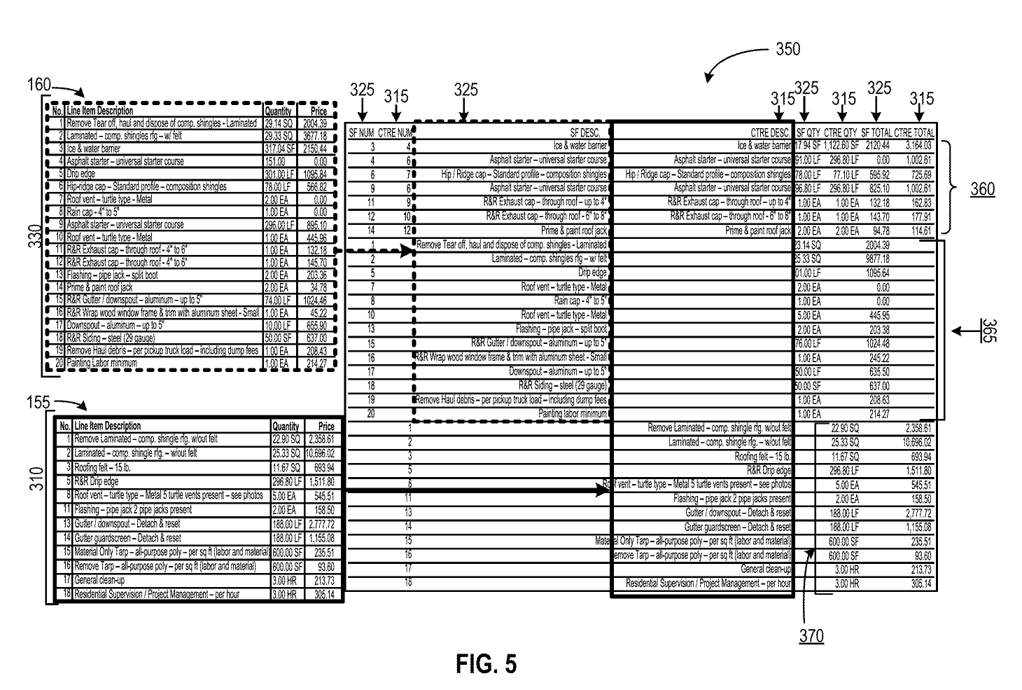

At step 215, data from the identified first line-items may be extracted. For example, the extraction circuit 130 may extract data from the identified line-item page(s) 300 to generate a first line-item data set 155. The data set 155 may include various data attributes, extracted from the identified first line-items, which may be placed in an organized structure (e.g., in a tabular format, graph structure, key-value store, matrix format, hierarchical structure, or other data structure), such as a data table (shown in FIGS. 4 and 5). The data set 155 may store data attributes associated with descriptions and/or other notes, quantities, codes, resource amounts, and/or other line-items associated with the damage event, such as data attributes 315 (shown in FIG. 4).

The extraction circuit 130 may utilize one or more models to extract the data in the first line-item data set 155, in some implementations. The appropriate models to apply in step 215 may be determined, at least in part, by the affinity between the first document 188 and the template(s) 145 (e.g., determined in step 210). For example, if the affinity between the format of the first document 188 and the format(s) provided in the template(s) 145 meet or exceed a minimum affinity threshold, one or more rule-based models may be selected. For example, the minimum affinity threshold may be met if the data format or structure of the identified line-item page(s) 300 are 70% the same as the template(s) 145. Thus, it is possible for some data to meet the minimum affinity threshold despite being in a non-standardized format. In some implementations, the rule-based models may be or include rule-based AI model(s) 140. Conversely, if the minimum affinity threshold is not met, one or more generative AI model(s) 140 may be selected. The minimum affinity threshold may be higher or lower than 70%, in various embodiments.

In some instances, the extraction circuit 130 selects the rule-based model(s) to extract the first line-item data. For example, the extraction circuit 130 may determine that the format of the identified line-item page(s) 300 is the same as, or substantially similar to, the format of the template(s) 145. The rule-based model(s) may be deterministic model(s) stored in the memory 120, in some implementations. These rule-based model(s) may operate using one or more of the rule(s) 150 and/or the template(s) 145 to extract the first line-item data. For example, the rule-based model(s) may extract the first-item data through one or more fields defined in a selected or optimally matched template 145. In some implementations, the rule-based model(s) may be one or more of the AI model(s) 140 that operate using the rule(s) 150 and/or the template(s) 145. The extraction circuit 130 may input the identified line-item page(s) 300 into the rule-based AI model(s) 140. The rule-based AI model(s) 140 may then extract the first line-items into the data set 155 of a standardized format. For example, descriptions and/or other notes, quantities, codes, resource amounts, and/or other line-items may be tabulated into corresponding cells or other tabular sections. In some implementations, the terminology or language of the line-items extracted from the first document 188 is preserved in the data set 155. Therefore, the extraction circuit 130 can organize the data extracted from the identified line-item page(s) 300 into the standardized format or framework without modifying the extracted data content, in some implementations.

In some instances, the extraction circuit 130 selects the generative AI model(s) 140. For example, the extraction circuit 130 may determine that the format of the identified line-item page(s) 300 is not substantially similar to the format of the template(s) 145 (e.g., below the minimum affinity threshold). For example, the identified line-item page(s) 300 may be in a non-standardized format. The generative AI model(s) 140 may be configured to extract the first line-items to generate the data set 155 of a preferred or standardized format. The generative AI model(s) 140 may do so despite the dissimilarity between the data formats. For example, the generative AI model(s) 140 may utilize a prompt (or be otherwise trained) to extract line-items from the identified line-item page(s) 300 that are otherwise not recognizable through a rule-based model. The generative AI model(s) 140 may then place the extracted first line-items into the data set 155. For example, descriptions and/or other notes, quantities, codes, resource amounts, and/or other line-items may be tabulated into corresponding cells or other tabular sections. In some implementations, the terminology or language of the line-items extracted from the first document 188 is preserved in the data set 155. Therefore, the extraction circuit 130 may organize the data extracted from the identified line-item page(s) 300 into the standardized format or framework without modifying the extracted data content.

In some implementations, the extraction circuit 130 may select multiple models to generate the data set 155. The selected multiple models may be a combination of any models stored in the memory 120. That is, the models may include both deterministic model(s) (e.g., rule-based models operating with the rule(s) 150 and/or template(s) 145) and AI model(s) 140 (e.g., either rule-based or generative models). The extraction circuit 130 may first implement a deterministic model and subsequently, if necessary, implement an AI model 140. For example, the extraction circuit 130 may implement a deterministic model to compare the substance of the identified line-item page(s) 300 to one or more of the template(s) 145 to identify data in the identified line-item page(s) 300 satisfying the minimum affinity threshold (e.g., sections that may conform to the template(s) 145). The deterministic model may additionally or alternatively implement one or more of the rule(s) 150 to perform the comparison. Accordingly, the extraction circuit 130 may identify a first data group that satisfies the minimum affinity threshold and a second data group that does not satisfy the minimum affinity threshold. The extraction circuit 130 may then select a model to extract the line-item data from each data group. For example, the extraction circuit 130 may implement a deterministic rule-based model to extract the line-item data from the first data group using one or more of the rule(s) 150 and/or template(s) 145. The extraction circuit 130 may implement an AI model 140 to extract the line-item data from the second data group. As another example, line-items from the first data group may be extracted with a rule-based AI model 140 and line-items from the second data group may be extracted with a generative AI model 140. The extraction circuit 130 may combine the extracted line-items from each data group to generate the data set 155.

At step 220, second line-item data may be received. For example, the second document 198 may be received, by the processor(s) 115, from the second computing device 190. The second document 198 may be generated by the report generator 197 in response to a damage event. For example, a second party (e.g., a property protection service such as an insurance company, handler of such a service/company, or other primary entity of the reconciliation system 105) may be contacted to assess a roof damage reported by a customer (e.g., the same roof damage as assessed by the first party, or the same roof damage corresponding to the first document 188). The second party may provide input data to the report generator 197 to generate a report (e.g., the second document 198) corresponding to the roof damage. The communications interface 199 may be interfaced with the communications interface 165 (e.g., through the network 175) to transmit the second document 198 to the reconciliation system 105.

In some implementations, the reconciliation system 105 generates the data set 160 in a similar manner as with the data set 155. For example, the extraction circuit 130 may extract the data from the second document 198 to organize the second line-item data into the data set 160 (e.g., in the form of a data table). In some implementations, the second line-item data is received in a format similar to the standardized format. The extraction circuit 130 may then implement one or more rule-based models (e.g., rule-based AI model(s) 140, deterministic models, etc.) to extract the second line-item data to generate the data set 160. If the second document 198 is received in a different format, the extraction circuit 130 may implement one or more other models, such as the generative AI model(s) 140. In some implementations, the extraction circuit 130 may implement multiple models to extract the data from the second document 198. For example, the extraction circuit 130 may implement a deterministic model to extract a first data group from the second document 198 and an AI model 140 to extract a second data group from the second document 198. The extraction circuit 130 may select which models to implement for data extraction based on an affinity between the data in the second document 198 and the template(s) 145 (as is done for the first document 188). Like the data set 155, the extraction circuit 130 may generate the data set 160 without modifying the substance or terminology of the data extracted from the second document 198.

In some implementations, the second line-item data is received in the standardized format. For example, the second document 198 generated by the report generator 197 may already include the second line-item data in the data set 160. Thus, the reconciliation system 105 need not generate the data set 160. Alternatively, the second document 198 may include the second line-item data in such a form that is easily tabulated into the data set 160. Thus, the reconciliation system 105 need not identify the second plurality of line-items or extract data to generate the data set 160.

At step 225, the first line-item data and the second line-item data may be compared. For example, the matching circuit 135 may generate a comparison of the data set 155 and the data set 160. After comparing the data sets 155 and 160, the matching circuit 135 may generate a reconciliation report or comparison report, shown as reconciliation document 350 in FIG. 5. The reconciliation document 350 may include all line-items identified and extracted from the first document 188 and the second document 198, including line-items that appear in both line-item data sets and line-items that only appear in one of the first or second line-item data sets. For example, FIG. 5 shows the reconciliation document 350 having a plurality of first line-items 310 and a plurality of second line-items 330.

Data items to match may be identified at step 225. For example, the matching circuit 135 may identify a first set of one or more data items from the data set 155 to match one or more data items from the data set 160. These are shown as matched line-items 360 in FIG. 5. The matching circuit 135 may identify the matched line-items 360 based on common data attributes. For example, the data set 155 may include first line-items 310, each having a plurality of data attributes 315. One of the data attributes 315 may be a line-item description. Similarly, each of the second line-items 330 of the data set 160 may have a plurality of data attributes 325, including line-item descriptions. The matching circuit 135 may identify one of the first line-items 310 from the data set 155 having a description that is the same as, or is substantially similar to, a description of one of the second line-items 330 of the data set 160. This may be done for all first line-items 310 (e.g., or for all second line-items 330). The matched line-items 360 may be grouped or otherwise organized together on the reconciliation document 350. In this way, data attributes of a specific line-item from each of the first and second parties may be easily compared to identify discrepancies between values provided by each party. FIG. 5 illustrates the grouping and organization of the matched line-items 360 on the reconciliation document 350.

Data items not to match may also be identified at step 225. For example, the matching circuit 135 may identify a second set of one or more data items from the data set 155 not to match one or more data items from the data set 160. These are shown as unmatched line-items 365. Like the matched line-items 360, the matching circuit 135 may identify the unmatched line-items 365 by comparing data attributes. The matching circuit 135 may identify one or more of the first line-items 310 that does not have the same, or does not have a similar, description as any of the second line-items 330. The unmatched line-items 365 may be grouped or otherwise organized together on the reconciliation document 350, as shown in FIG. 5. In this way, data attributes that were provided only by the first party (e.g., by the first computing device 180) and not by the second party (e.g., not by the second computing device 190) may be easily identified.

In some implementations, the matching circuit 135 may include or implement one or more of the models to identify the matched line-items 360 and the unmatched line-items 365. For example, the matching circuit 135 may implement one or more models (e.g., the rule-based AI model(s) 140, the generative AI model(s) 140, the deterministic models, etc.) to determine whether line-items match. The rule(s) 150 utilized by the rule-based models may be used to match line-items despite variations between their descriptions. Similar to steps 215 and 220, the matching circuit 135 may implement more than one model to perform the comparison, based on the substance of the data sets 155 and 160. Similar to the matched line-items 360 and the unmatched line-items 365, the matching circuit 135 may identify a third set of one or more data items from the data set 160 not to match one or more data items from the data set 155. These are shown as unmatched line-items 370 in FIG. 5. The unmatched line-items 370 may be grouped or otherwise organized together on the reconciliation document 350, as shown in FIG. 5. In this way, data attributes that were provided only by the second party (e.g., by the second computing device 190) and not by the first party (e.g., not by the first computing device 180) may be easily identified.

The matching circuit 135 may match one or more of the first line-items 310 to one or more of the second line-items 330 based on a degree of confidence. As an example, the matching circuit 135 may implement one or more of the rule-based models, such as the rule-based AI model(s) 140 to compare a description of a selected line item of the first line-items 310 with the descriptions of the second line-items 330. The AI model(s) 140 may identify a matching line item of the second line-items 330 having the same description as the description of the selected line item of the first line items 310. In this instance, the AI model(s) 140 may provide a strong degree of confidence that the line-items. For example, one of the matched line-items 360 may have a description “Ice & water barrier” in the data set 155 and the same description “Ice & water barrier” in the data set 160 (shown in FIG. 5). Because the line-items share the same description, the matching circuit 135 may match the line-items with a strong degree of confidence. In some implementations, the matching circuit 135 matches line-items having only 100% confidence or certainty that the line-items are the same. Therefore, the line-items that do not have a certain match are unmatched items (e.g., the unmatched first line-items 365 and 370). In some implementations, matching the line-items in this way may additionally or alternatively be achieved by models other than the AI model(s) 140, such as by one or more deterministic model(s) operating with the rule(s) 150.

In some implementations, however, the matching circuit 135 may match line-items that do not have a 100% confidence level or exact match. For example, the matching circuit 135 may match line-items that have at least a threshold degree/strong degree of confidence (e.g., 100% confidence is not required). In some embodiments, the matching circuit 135 may implement or utilize one or more of the models to determine that line-items with similar, but not exact, descriptions match. In some implementations, the AI model(s) 140 may match line-items with description differences such as differences in letter capitalization, abbreviations, punctuations, symbols, etc. For example, the AI model(s) 140 may determine that one of the first line items 310 with a description “R&R Exhaust cap – through roof – up to 4 inches ” matches one of the line-items 330 with a description “R&R Exhaust cap (through roof) – up to 4 in.” The determination may be made by one of a plurality of models, including the AI model(s) 140 or other rule-based model(s) operating with rules to correlate such description differences. In some implementations, the implemented AI model(s) 140 may be generative AI or other language processing model(s), such as LLM(s). Thus, line-items may be matched even if they contain language variations. For example, a line-item described as “asphalt starter” may be matched with a line-item described as a “starter shingle.” In some implementations, the matching circuit 135 matches items whose similarity have a minimum threshold degree of confidence (e.g., 85% confidence or another threshold value). Therefore, the line-items whose degree of confidence fall below the minimum threshold degree of confidence are line-items with no matches (e.g., the unmatched first line-items 365 and 370).

In the implementations described herein, the matched line-items 360 and the unmatched line-items 365 and 370 are determined based on a comparison of description(s) of each line-item. However, it should be understood that this comparison may be performed by comparing another one of, or a combination of, the data attributes 315.

In some implementations, the reconciliation system 105 may store line-item data generated in the process 200. For example, the first line-item data set 155, the second line-item data set 160, and/or the reconciliation document 350 may be stored in a designated location (e.g., within the memory 120, in the database 170, in the network 175, etc.). The stored line-item data may be used to optimize the reconciliation system 105. For example, the rule(s) 150 and/or the AI model(s) 140 may be updated over time to optimize line-item match identification. As one example, the matching circuit 135 may not match two line-items having a 75% degree of confidence but the user may determine that they are indeed a match upon reviewing the reconciliation document 350. Thus, the rule(s) 150 and/or the AI model(s) 140 may be updated (e.g., with new terminology) such that the match may be identified by the reconciliation system 105 in the future. Additionally, the line-item data may be accessed by a user to allow the user to selectively update the rules(s) 150 and/or prompts or algorithms for the AI model(s) 140. The stored line-item data may also be used to track data trends over time. For example, estimates from the first party relating to roof damage events may be stored and compared to determine that the first party, over time, has increased repair rates. This may be used by the second party to help the second party generate reports that better reflect the estimates of the first party. Overall, stored line-item data may be utilized to dynamically update the reconciliation system 105 to reflect estimate changes or trends.

FIGS. 3-5 provide an example of line-item identification, extraction, and classification performed by one or more components of the system 100. The illustrated documents and corresponding line-items may relate to information for responding to roof damage. However, it should be understood that the identification, extraction, and classification may be performed to reconcile information discrepancies related to various other events, including automobile damage, water damage (e.g., burst pipes), fire damage, or other property damage. Further, the processes disclosed herein may also be used to reconcile discrepancies related to other event information, such as medical events, theft event, or other events.

Referring now to FIG. 3, an illustration of identified line-item data is shown and described with respect to FIGS. 1 and 2, according to some embodiments. In the illustrated example, the first document 188 is shown to have multiple pages including text, tables, images, graphics, and other elements. The identification circuit 125 may receive the first document 188 and identify pages or segments of the first document 188 that contain line-items. For example, the identification circuit 125 may identify the identified line-item pages 300 from the first document 188.

The identified line-item page(s) 300 may include various data 305 that may correspond to the roof damage event. For example, the various data 305 may include one or more text data sections relating to item descriptions, notes, or other text data sections, as well as one or more nominal data sections relating to data values such as item numbers, quantities, unit costs, tax, profit margins, replacement values, depreciation values, or other nominal data sections. The data 305 within the identified line-item page(s) 300 may later be extracted.

Referring now to FIG. 4, an illustration of extracted line-item data is shown and described with respect to FIGS. 1 and 2, according to some embodiments. The extraction circuit 130 may extract data 305 from the identified line-item pages 300. For example, a plurality of first line-items 310 may be extracted from the data 305. Further, a plurality of data attributes 315 may be extracted from each of the first line-items 310. The attributes 315 may correspond to one or more of the various data 305 identified in the identified line page(s) 300 (e.g., descriptions, notes, quantities, etc.). Each of the first line-items 310 and their corresponding data attributes 315 may be organized into the data set 155. As previously described, the extraction circuit 130 may extract the data in such a way to preserve the original substance or terminology from the identified line-item pages 300, in some implementations.

In some implementations, some of the data attributes 315 extracted from the first line-items 310 are excluded from the data set 155. For example, the data set 155 is shown to only include four of the eight data attributes 315 extracted from the data 305. The data set 155 may be limited to include predefined attributes, such as those defined in the template(s) 145, the rules(s) 150, or in prompts applied to the AI model(s) 140. For example, the predefined attributes may include common attributes or valuable attributes that are included in most damage estimate documents.

In some implementations, the extraction circuit 130 may identify notes on the line-item page(s) 300 and determine their corresponding first line-item(s) 310. For example, a line item of the first line-items 310 is shown to include notes 316 included with, or part as, its description (or another of the data attributes 315). The notes 316 and/or the description may span multiple lines or columns on the identified line-item page(s) 300. Thus, the extraction circuit 130 may, for example by one or more of the AI model(s) 140, accurately determine the beginning and end of the notes 316 and/or description. In some implementations, the first line-item page(s) 300 include only notes 316 and a description is not identified. In this instance, the extraction circuit 130 may identify and extract a description from the notes 316. This reduces the likelihood that the notes 316 may be inadvertently grouped with an incorrect line-item, grouped as a new-item, or even completely omitted from the reconciliation document 350.

Referring now to FIG. 5, an illustration of a comparison between line-item data is shown and described with respect to FIGS. 1 and 2, according to some embodiments. As shown previously in FIGS. 3-4 and described with respect to FIGS. 1-2, the data set 155 is generated by the reconciliation system 105. As previously described with respect to FIGS. 1-2, the data set 160 corresponds to the plurality of second line-items 330 extracted from the second document 198. The data set 160 is generated by the reconciliation system 105 in a similar manner as that of the data set 155.

As previously described with respect to FIGS. 1 and 2, the matching circuit 135 compares the data sets 155 and 160 to generate the reconciliation document 350. The reconciliation document 350 may include line-items that were included in both the data sets 155 and 160, shown as matched line-items 360. The reconciliation document 350 displays the matched line-items 360 in a format to allow a user to easily identify the information discrepancies between the information provided by each party. For example, an “Ice & water barrier” line item from the data set 155 is matched with an “Ice & water barrier” line item from the data set 160 and displayed as one of the matched line-items 360. Common data attributes 315 and 325 for each of the matching line-items are placed near each other, in some implementations. For example, the data attributes 315 include quantity estimates and total estimates from the first party, and the data attributes 325 include quantity estimates and total estimates from the second party. These attributes 315 and 325 may be placed in adjacent columns. Thus, the user may easily identify and compare the attribute value differences between parties.

The reconciliation document 350 may include line-items from the data set 155 that do not match any line-items from the data set 160, shown as unmatched line-items 365. Similarly, the reconciliation document 350 may include line-items from the data set 160 that do not match any line-items from the data set 155, shown as unmatched line-items 370. Thus, the user may easily identify line-item estimates that are only provided by one party.

In some implementations, the reconciliation document 350 may include an additional area corresponding to potential line-item matches. For example, the matched line-items 360 represent line-items that are certainly, or near certainly, a match, with the remaining line-items either unmatched line-items 365 or unmatched line-items 370. However, some of the unmatched line-items 365 and 370 may be a possible match (e.g., having identified similarity but failing to meet a minimum threshold degree of confidence). Thus, the possibly matching line-items may be organized in a separate section of the reconciliation document 350. Therefore, the user may easily identify line-items that may match, allowing the user to confirm or reject the potential match.

In some implementations, the reconciliation document 350 is provided to the user to be approved. That is, the processes described herein (e.g., the process 200) may be considered a human-in-the-loop (HTIL) process. As an example, the user may review the reconciliation document 350 and determine that at least one of the unmatched line-items 365 should be matched to at least one of the unmatched line-items 370. The user may then provide an input (e.g., through the second computing device 190) to cause the reconciliation system 105 to update the reconciliation document 350 to match the selected line-items. Such a process allows validation of the automated system output to ensure accuracy and allows the user to maintain a degree of control over the contents of the reconciliation document 350. In some implementations, the input provided by the user may be used to refine the reconciliation system 105 over time. For example, as previously described, the user input may be implemented to revise the rule(s) and/or the AI model(s) 140. Additionally or alternatively, the reconciliation system 105 may provide a feedback mechanism. For example, the user may provide feedback relating to desired changes to the system 100, and such feedback may be implemented within the reconciliation system 105 (e.g., in the rule(s) 150 and/or the AI model(s) 140).

### Additional Cosideration

The arrangement, construction, and description of the systems and methods as shown in the various exemplary examples are illustrative only. While some examples have been described herein, several modifications and/or adjustments are possible (e.g., variations in sizes, dimensions, structures, shapes, and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative examples. Other substitutions, modifications, changes, and omissions can be made in the design, operating conditions, and arrangement of the exemplary examples without departing from the scope of the present disclosure.

The present disclosure contemplates methods, systems, and program products on any machine-readable media for accomplishing various operations. The examples of the present disclosure can be implemented using existing computer processors, or by a special purpose computer processor for an appropriate system, incorporated for this or another purpose, or by a hardwired system. Examples within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium, which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data, which cause a general-purpose computer, special purpose computer, or special purpose processing machines to perform a certain function or group of functions.

As used herein, an element or step recited in the singular and proceeded with the word “a” or “an” should be understood as not excluding plural elements or steps, unless such exclusion is explicitly recited. Furthermore, references to “exemplary example,” “one example,” or “some example” of the present disclosure are not intended to be interpreted as excluding the existence of additional examples that also incorporate the recited features.

It should be noted that the term “exemplary” and variations thereof, as used herein to describe various examples, are intended to indicate that such examples are possible examples, representations, or illustrations of possible examples (and such terms are not intended to connote that such examples are necessarily extraordinary or superlative examples).

The patent claims at the end of this document are not intended to be construed under 35 U.S.C. § 112(f), unless traditional means-plus-function language is expressly recited, such as “means for” or “step for” language being expressly recited in the claim(s).

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples, or that one or more examples necessarily include logic for deciding, with or without other input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art may recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, or “at least one of A, B, or C” is used, in both cases such usage should be interpreted as covering any permutation of A, B, or C, alone or in combination, unless expressly indicated otherwise (e.g., “a system having at least one of A, B, and C” would include systems that have A alone, B alone, C alone, A and B together, A and C together, B and C together, and A, B, and C together). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.” Further, unless otherwise noted, the use of the words “approximate,” “about,” “around,” “substantially,” etc., mean plus or minus ten percent.

The term “coupled” and variations thereof, as used herein, means the joining of two members, directly or indirectly, to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method for reconciling multiple documents for responding to damage to a home or other property, the method comprising:
receiving, by one or more processors, a first document prepared by a first party;
identifying, by the one or more processors, a plurality of first line-items within the first document relating to responding to the damage;
extracting, by the one or more processors, data from the identified first line-items to generate a first line-item data set;
receiving, by the one or more processors, a second line-item data set relating to responding to the damage and prepared by a second party; and
generating, by the one or more processors, a comparison of the first line-item data set and the second line-item data set, generating the comparison comprising:
identifying a first set of one or more data items from the first line-item data set determined to match one or more data items from the second line-item data set; and
identifying a second set of one or more data items from the first line-item data set determined not to match one or more data items from the second line-item data set.

2. The method of claim 1, wherein extracting the data comprises extracting descriptions, quantities, and resource amounts associated with the first line-items.

3. The method of claim 1, wherein generating the comparison further comprises identifying a third set of one or more data items from the second line-item data set determined not to match one or more data items from the first line-item data set.

4. The method of claim 1, wherein the first party comprises a contractor.

5. The method of claim 1, wherein receiving the second line-item data set comprises receiving a second document comprising a plurality of second line-items relating to responding to the damage and extracting, by the one or more processors, the second line-item data set from the plurality of second line-items.

6. The method of claim 1, wherein the first line-item data set and the second line-item data set comprise descriptions, and wherein generating the comparison comprises comparing the descriptions and determining whether to identify data items within the first set of data items or the second set of data items based on a similarity of the descriptions.

7. The method of claim 1, wherein at least one of the extracting or the generating steps are performed using one or more large language models.

8. The method of claim 1, wherein extracting data from the identified first line-items to generate a first line-item data set comprises identifying data items of the first line-item data set within the identified first line-items using at least of one a template or a rule set.

9. The method of claim 1, wherein the extracting step is performed using a language model, and wherein the first document comprises a non-standardized format, and wherein extracting data from the identified first line-items to generate a first line-item data set comprises identifying data items of the first line-item data set within the identified first line-items using the language model.

10. A system to reconcile multiple documents for responding to damage to a home or property, the system comprising:
one or more processing circuits configured to:
receive a first document prepared by a first party;
identify a plurality of first line-items within the first document relating to responding to the damage;
extract data from the identified first line-items to generate a first line-item data set;
receive a second line-item data set relating to responding to the damage and prepared by
a second party;
generate a comparison of the first line-item data set and the second line-item data set, wherein the one or more processing circuits are configured to:
identify a first set of one or more data items from the first line-item data set determined to match one or more data items from the second line-item data set; and
identify a second set of one or more data items from the first line-item data set determined not to match one or more data items from the second line-item data set.

11. The system of claim 10, wherein extracting the data comprises the one or more processing circuits to extract descriptions, quantities, and resource amounts associated with the first line-items.

12. The system of claim 10, wherein generating the comparison further comprises the one or more processing circuits to identify a third set of one or more data items from the second line-item data set determined not to match one or more data items from the first line-item data set.

13. The system of claim 10, wherein the one or more processing circuits are configured to extract the data by:
extracting a first portion of the data using at least one of a template or a rule set, the first portion of the data in a standardized data format; and
extract a second portion of the data using one or more AI models, the second portion of the data in a non-standardized data format.

14. The system of claim 10, wherein receiving the second line-item data set comprises the one or more processing circuits to receive a second document comprising a plurality of second line-items relating to responding to the damage and extract the second line-item data set from the plurality of second line-items.

15. The system of claim 10, wherein the first line-item data set and the second line-item data set comprise descriptions, and wherein generating the comparison comprises the one or more processing circuits to compare the descriptions and determine whether to identify items within the first set of data items or the second set of data items based on a similarity of the descriptions.

16. The system of claim 10, wherein the one or more processing circuits are configured to conduct at least one of the extracting or the generating using one or more large language models.

17. The system of claim 10, wherein extracting data from the identified first line-items to generate a first line-item data set comprises the one or more processing circuits to identify data items of the first line-item data set within the identified first line-items using at least of one a template or a rule set.

18. The system of claim 10, wherein the one or more processing circuits are configured to conduct the extracting using a language model, and wherein the first document comprises a non-standardized format, and wherein extracting data from the identified first line-items to generate a first line-item data set comprises the one or more processing circuits to identify data items of the first line-item data set within the identified first line-items using the language model.

19. One or more non-transitory computer-readable storage media having instructions thereon that, when executed by one or more processors, cause the one or more processors to perform operations comprising:
receiving a first document prepared by a first party;
identifying a plurality of first line-items within the first document relating to responding to damage to a home or property;
extracting, using one or more AI models, the one or more AI models selected based on a format of the first document, data from the identified first line-items to generate a first line-item data set;
receiving a second line-item data set relating to responding to the damage and prepared by a second party; and
generating, using the one or more AI models, a comparison of the first line-item data set and the second line-item data set, generating the comparison comprising:
identifying a first set of one or more data items from the first line-item data set determined by the one or more AI models to match one or more data items from the second line-item data set; and
identifying a second set of one or more data items from the first line-item data set determined by the one or more AI models not to match one or more data items from the second line-item data set.

20. The non-transitory computer readable storage media of claim 19, wherein identifying the plurality of first line-items comprises identifying recorded information associated with each first-line item of the plurality of first line-items, and wherein extracting the data from the identified first line-items comprises extracting a description from the recorded information for each first line-item of the plurality of line-items.
